(19) United States
(12) Patent Application Publication
(10) Pub. No.: US 2025/0272651 A1
(43) Pub. Date: Aug. 28, 2025

(54) METHOD FOR DETERMINING A DIMENSION OF A PRODUCT IN A PRODUCT PRESENTATION DEVICE

(71) Applicant: Captana GmbH, Ettenheim (DE)

(72) Inventors: Thomas Schwarz, Hohberg (DE); Michael Unmüssig, Ettenheim (DE)

(21) Appl. No.: 18/290,842

(22) PCT Filed: Jul. 26, 2021
(86) PCT No.: PCT/EP2021/070820

§ 371 Date: Jan. 22, 2024

(51) Int. Cl. G06Q 10/087; A47F 10/02; G08B 21/18

(52) U.S. Cl. CPC G06Q 10/087; A47F 10/02; G08B 21/182; A47F 2010/025

(57) ABSTRACT

Method for determining a dimension of a product placed in a product presentation device, wherein the method involves the following steps, namely:

automatic detection of a change in a parameter that is representative of at least one dimension of the product, wherein the parameter is detected with the aid of an electronic sensor and the sensor is located in the product presentation device, and

automatic determination of at least one dimension of the product based on the detected change in the parameter.

### TECHNICAL FIELD

The invention relates to a method for determining a dimension of a product in a product presentation device.

The invention also relates to a method for monitoring inventory in a product presentation device.

### BACKGROUND

In the retail sector, there is a long-standing need to have reliable information on the dimensions of products offered for sale and their packaging. These dimensions can be used in retail to optimize the use of available presentation space as well as to control merchandise logistics. In the case of goods logistics, for example, it is a matter of recognizing the right time for refinishing products in order to apply this process efficiently, i.e., not starting too early, which unnecessarily ties up human resources, or not starting too late, because starting too late can lead to bottlenecks in the availability of the product in question on a shelf, which, in turn, can comprise a negative impact on sales figures.

Usually, the producers of the products do not systematically provide the dimensions of the products. The dimensions can also change over time, for example, because the packaging is subject to changes.

In addition, retailers do not have the resources to manually detect the dimensions of the plurality of products to be presented in the store, to build up a systematic, in particular, digitalized database in this regard and, in particular, to maintain it on an ongoing basis.

The object of the invention is therefore to provide a solution to this problem

### SUMMARY OF THE INVENTION

This task is solved by means of a method according to claim 1. The object of the invention therefore entails a method for determining a dimension of a product placed in a product presentation device, wherein the method comprises the following steps, namely, automatic detection of the change of a parameter that is representative of at least one dimension of the product, wherein the parameter is detected by means of an electronic sensor and the sensor is located in the product presentation device, and automatic determination of at least one dimension of the product based on the detected change in the parameter.

This task is furthermore achieved by means of an inventory monitoring method according to claim 11. The object of the invention therefore entails an inventory monitoring method for monitoring the inventory in a product presentation device in which at least one product can be placed, wherein, for the product, at least one dimension that is representative of the inventory monitoring, in particular, the depth of the product, is known in advance, in particular, in accordance with the method for determining a product placed in the product presentation device according to the invention, wherein the inventory monitoring method comprises the following method steps, namely automatic detection of a change in a parameter that is representative of at least one dimension of the product, wherein the parameter is detected by means of an electronic sensor, and the sensor is located in the product presentation device, and automatic detection of a change in the number of products, wherein the change in the representative parameter is evaluated against the at least one dimension that is representative of the inventory monitoring.

The measures according to the invention are therefore accompanied by the advantage that, directly in a product presentation device, the at least one dimension is automatically determined and then available that is required to optimize the use of the available presentation space as well as for optimized goods logistics decoupled from the manufacturer or supplier of the product, i.e., independently of information provided by the manufacturer or supplier, which can be outdated or incomplete or are also subject to changes over time.

Since the measures according to the invention allow an automatic as well as dynamic determination, i.e. an automated determination over time, of the at least one dimension of the product directly on the shelf, the manual detection of the dimensions of the product can be completely dispensed with. In accordance with the method, even at the time of determining the at least one dimension of the product, it is irrelevant which particular product is on the shelf. The assignment between the actual product and the detected dimension can be made at another time.

The determination of the dimensions is therefore much more flexible than a central digital database created on the basis of manufacturer's specifications and time-consuming to maintain manually, in which a link between product and dimensions is provided centrally stored via a server. The construction of such a digital database can now be carried out fully automatically on the basis of the at least one automatically determined dimension, wherein the respective at least one dimension is determined directly at the place where the products are presented in the product presentation device. The fully automatically determined dimensions of the product can then be used in a variety of ways within the scope of an inventory monitoring method.

Furthermore, particularly favourable embodiments and further embodiments of the invention result from the dependent claims as well as the following description.

As a parameter or its change that can be detected using the sensor, wherein the sensor is, of course, designed to detect the respective parameter, the following are listed here in a non-exhaustive manner:
a change in light or signal irradiation,
a pressure change,
a change in a signal propagation time,
a change in the optical image of an optically detected object, etc.

The product presentation device can be implemented as a stand-alone device, which is placed on a shelf for example. However, the product presentation device can also form a row of shelves or a shelf or an entire shelf. The product presentation device can also be, for example, a sales table or also a vending machine.

The product presentation device shall comprise at least one height, one depth, and one width, wherein the height essentially extends along the acceleration of the fall. The depth corresponds to a length between a front edge of the product presentation device and a rear edge of the product presentation device. If the product presentation device comprises a storage structure, such as a shelf, then the depth along this shelf extends from its front edge to its rear edge. The width extends along the front or back edge of the product presentation device.

If a storage structure is used, it can be, for example, a shelf or also a sales table for the presentation of products. The back and front edges are formed by the demarcation of a storage area in which one or a plurality of objects can be placed on the storage structure.

Also, in front of the front edge or behind the rear edge, there can be other structural elements of the product presentation device with other tasks. For example, there can be a shelving rail in front of the front edge for attaching (e.g., electronic) shelf labels or also a slim screen that essentially covers the shelving rail or forms it itself (video shelving rail).

In general, a product can be understood as a product with or without packaging. The products that are in the product presentation device can also be described with at least these three dimensions (product height, depth, width), wherein these product dimensions are defined in a local Cartesian coordinate system of the respective product, which can differ from the (Cartesian) coordinate system of the product presentation device. If, for example, a product is placed on a storage structure that is inclined at an angle with respect to the acceleration of fall, such as a shelf, in a product presentation device, the level of the storage structure forms a reference plane in which two of the product dimensions (e.g., the depth and the width) extend. In this example, the dimension of the product height normally extends to the reference plane and its direction therefore differs from that of the fall acceleration. When determining the product dimensions, it is therefore important to ensure that the correct coordinate system is used, for example, that the sensor in the product coordinate system or relative to it is correctly sufficient, or that a computer-aided computational adjustment or correction is made.

Basically, products can comprise a wide variety of shapes and, as a result, different dimensions. For goods logistics or shelf management, the depth, height and width of the product generally form the relevant dimensions, which is why embodiment types for detecting these dimensions are discussed below. It should be noted, however, that the person skilled in the art can also use the gauge presented here to detect other dimensions, such as the length of the product or product packaging diagonal or the product circumference or volume.

The sensor can comprise a fixed detection direction or detection area for the purposes of its detection activity. However, the sensor can also be designed in such a way that it comprises a variable detection direction or a variable detection area, which can be adjusted or changed either mechanically or electronically or electromechanically. This allows different areas in the product presentation device to be detected. Preferably, the dominant or middle detection direction of the sensor should be aligned in accordance with the product coordinate system in order to enable the simplest possible determination of at least one dimension. Thereby, if products are placed on a sloping shelf inclined against the acceleration of fall, it is favourable if an analogous inclination is also provided for a sensor positioned at the rear edge of the shelf, for example, so that the detection direction is essentially parallel to the shelf.

The detection area of the sensor can differ depending on the type of sensor and embodiment and, for example, be linear, cylindrical, cone-shaped or also club-shaped but can be modelled software-based, particularly with regard to its width. For this purpose, the sensor can be equipped, for example, with an optoelectronic detection system that comprises an optical lens configuration (one or a plurality of lenses, possibly even with an autofocus function) and an adjacent sensor array, on which the lens configuration maps an image of the detected environment or of the detected object. Via software-based selective activation (inclusion) or deactivation (omission or hiding) of elements of the sensor array (particularly the peripheral areas) during detection, the opening angle can be adapted to the respective scene to be detected.

Depending on the requirements, the width of the opening angle can be ring-shaped or also be changeable running along a function, or it can be set individually in different directions, i.e., independently of each other. For example, a first width of the opening angle on the plane or parallel to the plane of the storage structure can vary from sensor to sensor and be adapted to the individual object sizes to be detected or also their grouping, generally their storage spaces or the extent of the storage spaces. In contrast, for all installed sensors or at least for a group of these sensors, a second width of the opening angle can be set identically on a plane transverse to the plane of the storage structure. This means that areas of different widths in a shelf can be monitored by different sensors, whereas the distance between shelves does not flow into the detection because the shelves are not detected due to the relatively small (narrow) second width, meaning no detection errors occur.

In accordance with another aspect, the sensor can either be positioned in a variable location or fixed, which will be discussed in detail below.

In order to detect the representative parameter for the determination or to detect its change, the sensor can be detected from different directions or with different orientations, as well as from different locations.

This means that the detection can be carried out from different detection positions, which has been discussed below.

The sensor can be placed in a stationary manner on the product presentation device, for example, behind the products, for example, on the rear wall of a shelf or at the rear edge of the product. In this fixed position, the sensor comprises an immovable detection area or an immovable detection direction. Therefore, it can be favourable to use a sensor with a manually or also electronically adjustable variable detection area or variable detection direction in order to be able to carry out targeted detection. From this detection position, the depth, the width and the height for a product can be determined.

Analogously, the sensor can also be positioned at a fixed position above the products and carry out the detection from there. The depth, width and height can also be determined from this detection position.

However, the sensor can also detect from below, i.e., from below the products. From this detection position, at least the depth and width of the product can be determined.

However, the sensor can also be mounted on a sensor movement system that moves the sensor behind the products or also above the products. This means that the detection direction or the detection area moves through the product presentation device with the moving sensor. Since the sensor as such is already moving and its detection area moves with it, it can be favourable in this case to use a sensor with a fixed detection direction. Depending on the situation, a flexible, variable detection area or a fixed detection area can be used. This moving, i.e., location-variable detection position allows the determination of the specified dimension already mentioned in connection with the fixed detection position but in other areas of the product presentation device, for example, for individual product groups at different positions or also across product groups.

The sensor movement system can comprise at least one of the following embodiments, namely: a draw-wire-based sensor movement system, a belt-based sensor movement system, a gear/rack-based sensor movement system, a thread-based sensor movement system, a magnet-based sensor movement system.

These embodiment types can also occur in combination. For example, a draw-wire-based sensor movement system or a belt-based sensor movement system can pusher the horizontal movement or positioning of the sensor whilst a thread-based sensor movement system pushers the vertical movement or positioning of the sensor respectively.

However, the sensor can also be positioned on or at a conveyor, wherein the conveyor conveys the product in the product presentation device whilst simultaneously also transporting the sensor. This location-variable detection positioning is a moving detection position from which the sensor performs its detection with respect to a reference object. In this moving detection position, the sensor is positioned in such a way that it moves with the products and, so to speak, orientates itself “from the front” in the direction of a reference object, for example, in the direction of the rear wall or the rear edge of the storage structure or the presentation device. The reference object can be the rear wall or another suitable boundary or cover structure at the back edge of a shelf or a shelf. For example, the product presentation device can also be a shelf without a rear wall, wherein the wall of the commercial building behind it can be the reference object.

For example, the sensor can be attached to a pusher or pusher plate that presses or pushes the products towards the front edge of the product presentation device, and the detection direction of the sensor can be orientated towards the rear edge, wherein a wall located there, for example, acts as a reference object. Alternatively, a spiral can also be used, which can set into rotation to move the products in their spiral structure (i.e., the coil) towards the front edge of the product presentation device. In these embodiment types, the sensor can also be positioned in the spiral behind the last product, possibly also attached to the pusher or carrier, and perform the detection from its respective position along the spiral in the direction of the rear edge. In any case, the depth of a product can be determined from this detection position.

Such a pusher plate can also be designed, for example, to move objects to the front edge of the storage structure under the influence of gravity. However, in most cases, it is favourable if the product presentation device comprises a product guide drive that moves, for example, the pusher plate or the spiral. This drive can be implemented with the aid of an electromotive element or also with the aid of an elastic element, such as a spring, which is tensioned, for example, when the storage structure is loaded with objects and partially relaxes after or during the removal of an object and moves the remaining objects towards the front edge of the storage structure.

It is also possible to use a plurality of sensors at different (stationary or variable) detection positions and with different detection directions, in particular, intersecting detection directions, in order to carry out the detection for one and the same product in combination. The changes in the parameters that are representative of the dimensions of the product detected by these spatially distributed detection positions can be processed in combination after they have been detected, for example, in order to carry out a better or more accurate characterization or evaluation of the detected change. In this way, it is also possible to differentiate the detected change in different directions (i.e., according to the detection directions), which also makes it possible to derive changes in position for the products (stationary or location variables) detected by a plurality of sensors. Sensors of different types can also be used at different detection positions.

In other words, there are different positioning options within the product presentation device for detecting or changing at least one parameter that is representative of at least one dimension of the product, in order to determine at least one of the dimensions of height, width or depth of the product.

The determination of the respective dimension is carried out on the basis of the detection result or the detection results of the sensor, which are represented by detection data provided by the sensor, by a data processing device, which can be located directly in the sensor itself or externally to it, such as by means of a server or by means of a cloud-based solution for example, wherein an evaluation software is executed that evaluates the detection data with regard to the dimension(s) of the product. In this way, the sensor can be designed to perform a measurement cyclically, particularly periodically, in accordance with a preferred embodiment type. For this purpose, it can comprise timer electronics. For example, the sensor can detect data at intervals of a few seconds. Detections can also be carried out at non-periodic or unevenly long intervals. It is also possible for the detection to take place at random intervals within a time range or spread over the opening hours of a business premises or spread over the day.

The sensor can transmit or deliver its detection data via cable. A plurality of sensors of a product presentation device or also a plurality of sensors of a plurality of product presentation devices can also transmit their detection data via cable to a separate radio module, wherein this radio module is designed to forward the detection data wirelessly. The radio module thus transmits the detection data of a group of sensors from one or various product presentation devices. Such a group can be formed, for example, of the product presentation devices, each of which forms a row of shelves, or of product presentation devices, each of which is located in a row of shelves or on a shelf.

In accordance with a preferred embodiment type, the sensor is designed to transmit its detection data, which represents the detection of the object or product using radio-based transmission. Preferably, the sensor itself comprises an (integrated) radio module. If the sensor itself is designed to determine at least one dimension, it also transmits the dimension determined in this way via the radio module for further processing.

The sensor can comprise different embodiments or also a combination of different sensor technologies or embodiments. For example, the sensor can be designed as a pressure-sensitive sensor mat that comprises a plurality of pressure-sensitive elements, such as mechanical or capacitive detection elements, distributed over the surface of the sensor mat, which close an electrical circuit or influence its characteristics when a product is placed on the sensor mat. Analogously, a sensor mat with an array of light-sensitive elements can also be used, in which a number of these light-sensitive elements are covered and thus darkened by products deposited on the array, which can be detected electronically. With these solutions, at least the dimensions of depth and width of a product can be detected from the detection position from below. What all these embodiment types have in common is that the sensor elements must make contact with the product in order to deliver reliable detection results.

For detection from a different detection position, such as from above the products or from behind the products for example, it has proven to be particularly favourable if the sensor comprises at least one of the following embodiments (operating principles), namely:
a time-of-flight sensor
a camera
a 3D-camera system
a time-of-flight camera
a LIDAR (abbreviation for “Light detection and ranging”, also “Light imaging, detection and ranging”).

What all these embodiment types have in common is that they do not have to make direct contact with the product in order to provide reliable detection results. In this context, it should be emphasized that the sensors mentioned here are also excellently suited for the moving detection position.

In order to be able to detect other useful information for the retail trade directly on the shelf, it can be provided that the sensor also detects additional parameters, such as weight or temperature.

In principle, the determination of the dimensions of the product could be carried out continuously, i.e., continuously. This can be desirable under certain circumstances, for example, when organic naturally grown products, each of which comprises individual dimensions, must be taken into account. In other circumstances, however, it can be desirable not to determine the dimension continuously. Therefore, it can be favourable if the method only determines the dimensions of the product when a learning phase has been triggered.

Once the learning phase has been triggered, at least one dimension of the product can be determined specifically within the learning phase before this dimension, which is now defined, i.e., the known, is reused. The learning phase can be completed again. This can be done manually or also automatically, for example, by converging the automatically determined dimension to a value over time. The determined dimensions are stored and are available for optimizing the use of the available presentation space as well as for further goods logistics. Thus, at the end of the learning phase for a product, at least one value for at least one of its dimensions is fixed until a new learning phase is started. A fixed value enables simple and thus uncomplicated and clear goods logistics, because there is no need to deal with constantly changing data.

For example, the learning phase can be triggered or also terminated by signals received by the sensor, wherein wired or unwired transmission of the signal can be implemented. For example, a button can be provided for this purpose, which transmits the signal when pressed. For example, a mobile phone with a corresponding application can also transmit such a signal wirelessly.

As an alternative to this external trigger, the learning phase can also be started automatically based on the automatically detected change in the parameter. The learning phase is therefore started due to an internal trigger.

Therefore, it has proven to be particularly beneficial that the detected change in the representative parameter is checked for at least one trigger and that the learning phase is triggered when the presence of this trigger is detected.

Such a trigger can be that at least one quantity describing the representative parameter occupies, falls below or exceeds a certain value. This means that it can be triggered if the parameter or its change exceeds or falls below a threshold value, or if the parameter or its change is within or outside a certain expectation range. For example, the trigger can be that the sensor detects a parameter that indicates that the product presentation device or a section of it is empty, for example because a distance to a fictitious product is measured in the direction of the depth of the product presentation device that is greater than or equal to the depth of the product presentation device or the storage structure provided there.

Based on this internal trigger, it is possible to monitor when new products are refinished. However, it is irrelevant whether the products are the same with the same dimensions as before or whether other products with different dimensions are resized than before. With the aid of the method, the current at least one dimension of the product is always determined and made available for the optimal use of the presentation area as well as the optimization of goods logistics. This allows a dynamic redesign of the store or the shelf stocking, such as adapted to marketing campaigns, etc. for example, namely without any manual adjustment effort with regard to the product dimension(s) to be taken into account, because these are provided automatically in the course of stocking the shelves with products.

Such an internal trigger can therefore also be based on the change in the quantity describing the representative parameter in the temporal context. For example, the trigger can be based on the fact that at least one dimension calculated from the change in the representative parameter does not correspond to the previously stored or previously determined dimension in the case of automatic repeated control over a period of time. This means that it is automatically detected when at least one dimension of the product(s) in the product presentation device changes, for example because other products or products with a different packaging or also with a different orientation have been placed in the product presentation device. This can also be used to detect clutter on a shelf in order to subsequently start a clarification or reordering process in terms of goods logistics.

The trigger can also be that the detected change in the representative parameter is outside a previously defined range.

For example, the trigger can also be based on the recognition of a pattern, particularly in the temporal context. For example, the trigger can be predefined in such a way that a trained employee waves his or her hand three times through the sensor's detection area at a certain frequency or presses the sensor three times at that specific frequency to cause the trigger. Thus, the employee can simply tell the system performing the method according to the invention that a product with new dimensions is placed in the product presentation device and a new detection of at least one dimension is desired. In the present case, the sensor is designed to identify this particular hand movement on the basis of the resulting change in the detection results.

Artificial intelligence can also be provided (e.g., integrated into the sensor) that recognizes the trigger on the basis of previously trained criteria. Here, too, if the trigger is detected, a new determination of at least one dimension is carried out. The artificial intelligence can also independently determine the conditions for the presence of a trigger on the basis of the training. As discussed below, artificial intelligence can also be used to determine the dimensions.

A plurality of embodiment types have proven to be favourable for the automatic determination of at least one dimension.

Thus, the determination of the dimension of the product can be done directly from a single change in the parameter.

“Direct” here means that the dimension can be inferred from a single change in the parameter, because the change in the parameter (e.g., the change in the transit time of a signal in the case of a time-of-flight sensor) converted to the corresponding change in path is directly equated with the dimension of the product to be determined, for example. As discussed, the sensor can be a switch mat forming the sensor mat with a plurality of contacts evenly distributed across the surface of the mat that close when an object is placed on it, wherein it can be electronically determined how many such contacts (in a row) have been actuated. In this case, the change in the parameter corresponds to the number of contacts in one direction that are closed or opened. With the knowledge of the distance between the contacts, it is possible to convert to the dimension of the product by multiplying the number of actuated contacts by the distance.

Determining the dimensions of the product directly from a single change in the parameter is particularly favourable because very little memory and computing power is required by the determining device or data processing device. For example, it can easily be accommodated in the sensor itself. Furthermore, this embodiment type allows a clear traceability of where the measured values come from. Because a single change in the number of products is essentially sufficient to obtain a measurement result, it can be easily checked and reproduced. If, for example, an employee classifies new goods in the product presentation device, he or she can immediately query the determined dimensions and check them for plausibility. Faults, for example due to damaged sensor elements, can be detected immediately.

In accordance with another preferred embodiment type, the determination of the dimensions of the product can be made from a number of changes in the parameter.

For this purpose, a plurality of change processes are automatically determined and stored and evaluated with the aid of change data, which represent the parameter change detected in each case. For example, pre-programmed algorithms and statistical methods can be used for this purpose.

The determination of the dimensions of the product from a number of changes in the parameter offers the advantage that a more precise determination of at least one dimension is possible and that errors, particularly detection errors, can be detected and also filtered out. A distinction can also be made between parameter changes that are not to be used to determine at least one dimension, for example, because their temporal behaviour and/or their value-related behaviour can be inferred from the presence of a hand movement on the shelf caused by a post-finishing process of an employee or product removal by a customer, and those which are to be used to determine the at least one dimension, because, for example, the above-mentioned temporal as well as behaviour in terms of value suggests that it cannot be the hand movements mentioned. Hand movements can be easily narrowed down in terms of value, because the dimensions (width/thickness) of hands are easily predictable and the speed of the hands on the shelf can also be easily predicted by measurement experiments.

For example, such a pre-programmed algorithm can include the following steps, namely:
sorting out those measured values that were only shorter than a certain time threshold within a certain range,
where applicable, sorting out those measured values that lie within or outside a certain range,
where applicable, conversion of the measured values to the distance to a reference parameter such as the depth of the product presentation device for example,
a division of the other values into categories, wherein each category comprises a representative value, such as the mean or median of the values within the category for example,
where applicable, sorting out those categories that were formed from only a few values,
a determination
the category with the lowest representative value, or
of two categories whose representative values are closest to each other, and
specifying the dimensions to be determined
based on the representative value of the category with the lowest value, or
on the basis of the difference between the representative values of the two categories and the most closely related representative values.

In this exemplary algorithm, those values that most likely do not correspond to a dimension of the product because they were detected when the product was placed in or taken out are sorted out. Even those values that are clearly outside the expected order of magnitude can also be sorted out. Furthermore, these are grouped into groups of measured values of similar size.

In accordance with another preferred embodiment type, the determination of at least one dimension can be carried out with the aid of artificial intelligence, which processes or evaluates the changes in the representative parameter.

This embodiment type allows for dynamic shelf management, in which little or no special action is required by the employee to detect new dimensions of new products within a product presentation device.

The artificial intelligence can be designed (trained) in such a way that it can distinguish between parameter changes that indicate the hand movements mentioned above and those parameter changes that can be used to determine at least one dimension. The artificial intelligence can also be trained to receive an external trigger to learn the dimension to be determined. Artificial intelligence can also be trained to recognize that a product dimension changes systematically, for example, because other products or products with different packaging dimensions are placed on the shelf, which provides an internal trigger for the teach-in of the new dimension.

For example, a pre-programmed algorithm can also be provided that processes the detected parameters or their modification and, on the basis of this processing, triggers or also stops the learning phase and also determines at least one dimension of the object (the product).

Furthermore, it should be noted that due to the product arrangement in the presentation device, in many cases, the information about a single dimension is sufficient to implement optimized goods logistics or optimized shelf management. In this context, it has proven to be particularly favourable that the dimension of the product is measured in the direction of the depth of the product presentation device or a storage structure, and that wherein the change in the parameter is given by a change in distance detected by the sensor in the direction of the depth of the product presentation device or the depth of the storage structure, and wherein the depth of the product is determined with the aid of the determined change in distance.

For goods logistics or shelf management, the depth of a product measured in the direction of the depth of the product presentation device or the storage structure is of particular importance, because this size (as discussed below) allows conclusions to be drawn about the number of products currently available as well as the maximum number that can be placed, particularly if the products are placed in a row in the direction of the depth of the product presentation device or the storage structure, and the depth available for product placement is known.

The change in distance can be detected, for example, if the sensor is designed as a camera, and the camera captures an image of a reference image or the size of that reference image. The reference image can be a symbol, such as a circle, but also, for example, the rear wall of the shelf and its edges for example. Because the size of the image of the reference image changes depending on the distance, the distance of the sensor to the reference image can be deduced from the detected image. The reference image can also be the product or its surface, or an image applied to its surface. However, it can also be a 2D code, such as a QR code or a barcode for example. It can also be provided that the distance measurement is not carried out or not only on the basis of the size of the image of the reference image, but on the basis of which part or part of the reference image is detected. For example, as discussed, the sensor can sit on a pusher and detect the rear wall of the product presentation device or the storage structure. The rear wall can now comprise a pattern as a reference image that extends over a large part of the rear wall or over the entire rear wall, wherein the reference image consists of, for example, a 2D code or also an image that matches the product. Based on the information about which part of the reference image is detected by the camera, the distance can be calculated back to the computer.

In accordance with a preferred embodiment type, a sensor based on time-of-flight measurement of a sensor signal is used as a sensor, in particular, with a resolution in the cm range or sub-cm range. The determination of the change in distance is therefore carried out by means of time-of-flight measurement, specifically by determining a change in the runtime between two runtime measurements. In this case, the sensor uses a transmitter to transmit the sensor signal that hits an object and is reflected from there and measures the time that elapses since it was emitted until this sensor signal is received again by a receiver of the sensor. Based on the time it takes for the signal to travel from the transmitter to an object, particularly to the product to be detected, and back to the receiver, the distance between the sensor and the object is inferred knowing the speed of propagation of the sensor signal. In this preferred embodiment type, the transmitter and receiver (as well as the processing device for determining the transit time) are integrated into the sensor, i.e., the sensor is designed as a single piece. Alternatively, the transmitter can be placed next to the product and the receiver on the product presentation device, or vice versa so that only the time it takes for the signal to travel directly from the transmitter to the receiver is measured. To do this, however, the sensor must be designed in two parts.

In addition, in a retailer's store, such as a supermarket, an innovative inventory monitoring method can be used to monitor the inventory in a product presentation device in which at least one product can be placed, wherein, for the product, at least one dimension that is representative of inventory monitoring, in particular, the depth of the product, is known in advance.

This dimension can have been determined manually or semi-manually by the retailer in a variety of ways, or it can have been provided by a supplier or also a producer of the product and stored by the retailer in a digital database that can be retrieved. However, particular preference was given to determining the dimension in accordance with the method discussed earlier. The inventory monitoring method now consisted of the following method steps, namely automatic detection of a change in a parameter representative of at least one dimension of the product, wherein the parameter is detected by means of an electronic sensor and the sensor being located in the product presentation device, and automatic detection of a change in the number of products, wherein the change in the representative parameter compared to the at least one dimension representative of the inventory monitoring is assessed.

The sensor used here can differ from that of the previously discussed method and can therefore be implemented by means of a separate second sensor. Preferably, however, it is the same sensor that is also used in this method in the present context. it is therefore used in this inventory monitoring method to automatically detect the change in the representative parameter in the same way as in the method discussed above, wherein the sensor technology already discussed on the one hand is used and also the measures discussed in this context are used on the other hand.

The assessment of the change in the representative parameter compared to the dimension that is at least one representative of the inventory monitoring is to determine whether the change in the representative parameter was made in such a way that it can be reliably concluded that the number of products has been reduced or increased. Thus, changes to the representative parameter are discarded if they do not comprise a valid integer relation to the known dimension. Of course, deviations within reasonable limits can also be taken into account. Incidentally, the various embodiment types or measures up to artificial intelligence discussed in connection with the automatic determination of at least one dimension can also be used here.

A major advantage of this automatic determination of the change in the number of products, which is digitally communicated to a retailer's merchandise management system, is that the actual inventory is fully automatically available in real time in the retailer's digital merchandise management system, starting from an initial inventory for a specific product, which can comprise to be redefined from time to time.

In accordance with another aspect of the inventory monitoring method, it is checked whether the automatically detected change in the number of products leads to a fall below a threshold value of the number of products, wherein a restocking alarm is triggered in the event of a positive test result.

With the aid of this measure, the process of restocking or finishing the respective product in the merchandise management system can be triggered in good time. The need for refinishing can also be indicated on the electronic display plate belonging to the product so that the staff can be informed about this fact directly at the shelf without any further technical aids on site. The merchandise management system can also prioritize different products in order to deploy personnel efficiently if there is a need for refinishing simultaneously. The replenishment alarm, if generated directly in the sensor, can be transmitted electronically, for example, wirelessly, from the sensor to the merchandise management system.

In accordance with another aspect of the inventory monitoring method, it is checked whether an automatically detected change in the number of products leads to an exceedance of a threshold value of the change in the number of products, wherein a theft alarm is triggered if the test result is positive.

With this measure, it is possible for the first time to detect a potential theft directly in the product presentation device and therefore also to initiate measures at the time of detection, such as the triggering of the theft alarm directly by the sensor, which can generate an acoustic signal as an anti-theft alarm, for example, and/or transfer the theft arm digitally, for example, by radio, to the merchandise management system.

Both in connection with the restocking alarm and also in connection with the theft alarm, it has proven to be extremely favourable if product-specific or product group-specific threshold values are used in the test. These individual threshold values are defined by the merchandise management system and transmitted electronically to the sensors, for example, by radio, and stored where they are ultimately applied decentrally. For example, it has been shown that dairy products are usually purchased in large quantities by a single person, for example, in the order of 3 to 20 pieces, whereas razor blade packs are usually purchased only as individual items. Therefore, it can make sense to define a threshold value of two for razor blade packs and, on the other hand, to set no threshold value at all for dairy products, because these products are difficult to steal and are also quite cheap in relation to razor blades.

In the case of the merchandise management system, it has proven to be particularly favourable if an additional system component is activated or included in an automatic determination of the change in the number of products, in particular, a billing or cash register system to which the change in the number of products is communicated electronically, or an optical monitoring system with which a digital recording of the product presentation device is created, in which the change in the number of products has been detected.

This makes it possible to check directly with the aid of the billing or POS system whether the detection of the change in the number of products is correct, broken down to product level, and on the other hand, to validate whether all products removed from the product presentation device have been paid. In this way, shrinkage due to theft or also consumption can be determined directly in the store at the product level.

In addition, with the aid of the optical monitoring system, a corresponding recording can be created for each detected change in the number of products or marked in a continuous recording that documents the removal or also the loading process. This allows me to document the efficiency of the staff in the store and also to check the quality of the replenishment and subsequently also to improve it, particularly in the event of a restocking alarm. However, even in the event of an anti-theft alarm, the associated recording or recording sequence can be marked accordingly, for example, with the aid of metadata that makes it easier to find relevant recordings or also to filter them in relation to such recordings. This metadata can also be used to indicate the likelihood of theft, wherein the recording or sequences are automatically marked with a special colour, such as green for unproblematic, yellow for possible theft, and red for potentially identified theft. In the context of the razor blade example, for example, the removal of three packs could be classified as a suspected (possible) theft (marked in yellow), whereas the removal of ten packs, unless they are staff of the retailer, is evaluated with a high degree of reliability as a potential theft (marked in red). The recordings or sequences of recordings thus obtained that indicate theft can be transmitted digitally to a screen at the POS terminal, where the number of products affected is also displayed, allowing staff to clarify the incident with the person in question who can be seen in the recording. These recordings or sequences with associated product information and details of the number of products taken can also be transmitted directly to the department store detective's office or to his mobile communication device (smartphone or tablet computer) in order to inform him of the incident.

The internal radio module of the sensor can be designed to deliver the detection data as raw data or pre-processed, for example, via a wireless local area network (WLAN/WIFI) or via a mesh network configuration. Other de facto standardized communication protocols such as ZigBee or Bluetooth can also be used. It can also be provided that the sensors are equipped with a 4G- or 5G-radio module in order to pusher their radio traffic via a (public) mobile network and to act as IoT devices (IoT stands for Internet of Things). A separate 4G- or 5G-capable radio device can also serve as an access point for the sensors that are connected to this access point via radio or cable. Of course, other devices that are part of the infrastructure of a merchandise management system or a shelf logistics system can also serve as an IoT hub for the sensors. For this purpose, for example, cameras can be used, with the aid of which shelves are filmed and, where applicable, the above-mentioned openings or sequences of recordings are created. These cameras have 4G- or 5G-cellular capability and communicate using the sensors in accordance with a different communication protocol, preferably radio-based.

Of course, a proprietary communication method or communication protocol can also be used for the radio-based connection of the sensor, as is known, for example, from PCT/EP2014/053376, wherein its disclosure is included by reference with regard to the time-slot communication method described therein. However, in contrast to the system disclosed in PCT/EP2014/053376, this time-slot communication method is used here for communication between a sensor access point and a group of sensors assigned to this sensor access point. This proprietary communication method allowed extremely energy-saving operation of the sensors, but at the expense of the temporal availability of the sensors for radio communication. The wireless module of the sensor rarely switches from its sleep mode to its active mode in order to be available in terms of radio technology. Regardless of this, the sensor can carry out its sensing activity or perform other functions. The (collection) data generated in the process can then be submitted over time using the proprietary communication method.

Ultimately, it should be mentioned that the electronic devices described naturally comprise electronics. The electronics can be discrete or constructed by integrated electronics, or also a combination of both. Microcomputers, microcontrollers, Application Specific Integrated Circuits (ASICs), possibly in combination with analogue or digital electronic peripherals, can also be used. Radio devices usually comprise an antenna configuration for transmitting and receiving radio signals as part of a transceiver module. Preferably, the sensor is battery-operated.

These and other aspects of the invention result from the figures discussed below.

### BRIEF DESCRIPTION OF THE FIGURES

The invention is explained in more detail below with reference to the attached figures on the basis of exemplary embodiments, to which, however, the invention is not limited. Thereby, identical components in the various figures are provided with identical reference numbers. The figures schematically show:

FIG. 1 a sensor for use in the method described;

FIG. 2 a product presentation device with sensors fixed in the product presentation device;

FIG. 3 another product presentation device with a sensor movement system for vertical sensor movement of the sensor;

FIG. 4 another product presentation device with a product guidance structure and the sensor movement system;

FIG. 5 a product presentation device with a product guidance structure and a sensor movement system for both horizontal as well as vertical individual sensor movement;

FIG. 6 another product presentation device according to the invention with a product guidance structure and a sensor movement system for horizontal movement of vertically fixed positioned sensors,

FIG. 7 another exemplary embodiment of the sensor movement system,

FIG. 8 another exemplary embodiment of the sensor movement system,

FIG. 9 a product presentation device with one pusher per product guidance structure and a single movable sensor;

FIG. 10 a product presentation device with one pusher per product guidance structure and with sensors attached to the pushers;

FIGS. 11 to 12 a second exemplary embodiment of the sensor;

FIG. 13 use of the sensor in accordance with the second exemplary embodiment in a product presentation device;

FIGS. 14-15 a visualization to discuss the basic functioning of the sensor;

FIG. 16 a flowchart to visualize the methods discussed.

### DESCRIPTION OF THE EXEMPLARY EMBODIMENTS

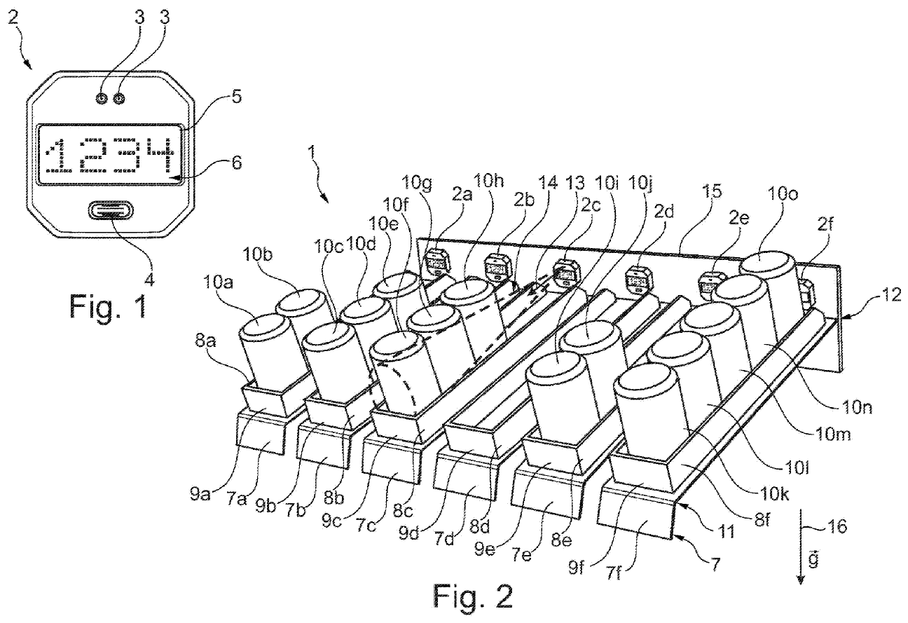

FIG. 1 shows a sensor 2 that comprises a sensor unit 3 for transmitting a signal and receiving the signal reflected off an object. In the present case, sensor unit 3 is therefore a time-of-flight sensor unit 3. The sensor 2 also comprises a button 4 that can be operated by a user to make settings or trigger functions. The button 4 has the significance of an external trigger. The sensor 2 also comprises a screen 5 for displaying information.

The screen 5 is designed as an energy-saving e-paper display and displays sensor identification data in the form of sensor ID 6, which allows a user to identify the sensor 2. For example, the sensor ID 6 can be equal to the last characters of the MAC address (Media Access Control Address) of the sensor 2 or correspond to another designed identification number for example, for which the corresponding MAC address is stored in a database. However, the identification of the sensor 2 can also be represented by other measures, such as a number or an alphanumeric string for example, or even a barcode or a QR code (QR stands for Quick Response).

The database can be accessed by means of a corresponding application on the user's mobile phone. The application also allows scanning of the sensor 2 (specifically, the screen content, the number or alphanumeric string, or the barcode or QR code) with a camera of the mobile phone, wherein the sensor ID 6 is automatically detected by means of image recognition so that scanning or photographing is possible as an alternative to manually entering the code in order to query the data on the sensor and on a related product or a plurality of products. In particular, a real-time inventory query can be carried out, i.e., a query as to whether the corresponding product assigned to the sensor 2 is still available in the warehouse or on another shelf.

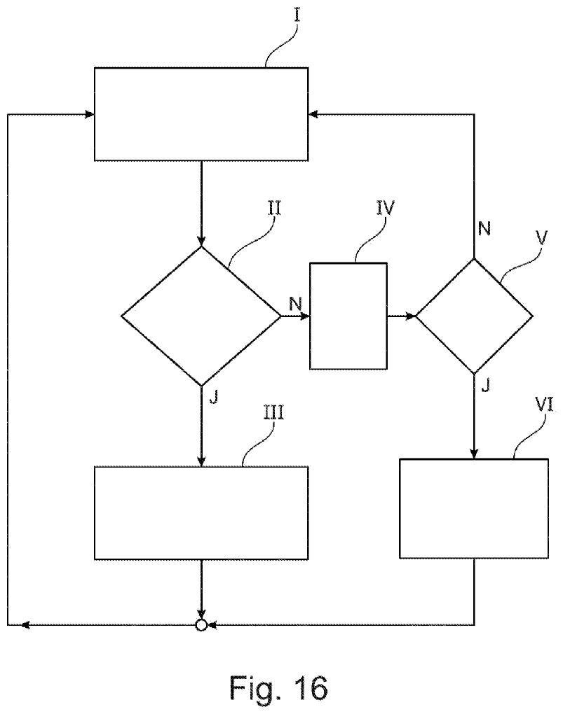

For this purpose, the sensor 2 comprises a radio module (which is installed in the housing and is therefore not visible), which enables radio-based communication of the sensor 2. This means that the sensor 2 can transmit its detection data wirelessly via the radio module. Depending on which mode the sensor is currently in, the detection data represents either the automatically determined at least one dimension of a product or a change in the number of products, which is discussed in detail in the flowchart of FIG. 16.

As described in the general part of the description, radio communication of the sensor 2 can take place in a wide variety of ways. In the example given here, radio communication is assumed with an access point, which in turn is connected via a wired network to a server on which ERP software is running.

The sensor 2 detects the presence of objects within its detection area with the aid of its sensor units 3. The signal data processing required for this is carried out in the sensor 2 with the aid of sensor electronics. The sensor electronics are essentially implemented by a microcontroller on which sensor software is processed. The sensor software is programmed to perform a method to determine the depth of a product placed on a shelf. It automatically detects the change in a parameter that is representative of the depth of the product, which is detected with the aid of the sensor 2. The change in the parameter that is representative of the depth of the product is the change in the distance between the sensor and another object when the sensor is moved with the product, or between the sensor and the product or an object moving with the product. The sensor determines the distance with the aid of its sensor unit 3 by measuring the time-of-flight of the sensor signal and knowing the propagation speed for the sensor signal. This distance determination is essentially continuous or quasi-continuous over time, i.e., at discrete points in time. The sensor 2 monitors the observed distances over time with regard to a change that is valid for depth determination, as discussed in the general description of different embodiment types. So, the sensor software automatically determines the depth of the product based on the detected change in distance.

This method can be performed for a wide variety of detection positions, as discussed in the general part of the description, wherein these detection positions indicate from where the sensor 2 performs its detection FIGS. 2 to 11 show examples of fixed (locally fixed) as well as location-variable sensing positions in which the sensor can be positioned to carry out the method according to the invention, as well as the necessary measures to enable such positioning.

FIG. 2 shows a shelf 1 with fixed sensors 2a-2f. The sensors 2a-2f are attached to a rear wall 15 at fixed detection positions.

In front of the rear wall 15 there is a shaft-shaped storage structure 7, which is divided into six sections 7a-7f. The storage structure 7 or each section 7a-7f comprises a front edge 11 and a rear edge 12. At the rear edge 12, the storage structure 7 merges into the rear wall 15.

Products 10a-10o are located in storage structure 7. The rear edge 12 of the storage structure 7 is located above the front edge 11 in the direction of gravitational acceleration, which is visualized by the arrow 16. The bottom of the storage structure 7 is so smooth that objects placed on it 10a-12o automatically slide towards the front edge 11.

Each section 7a-7f comprises a product guidance structure 8a-8f. This product guidance structure 8a-8f guides the objects 10a-10o within a section 7a-7f each in a line, i.e., along an arrangement line.

The product guidance structure 8a-8f comprises a front boundary 9a-9f for each section 7a-7f to avoid objects 10a-10o falling out at the front edge 11. The boundary 9a-9f is so low that the foremost objects 10a, 10c, 10f, 10i and 10k, in particular, are clearly visible and can be easily removed after being lifted slightly. If one of these foremost objects 10a, 10c, 10f, 10i and 10k is removed, the object behind it slips down, i.e., towards the boundary 9a-9f.

Each of the sections 7a-7f is assigned a sensor 2a-2f. Each sensor 2a-2f comprises a detection direction 13 that extends from the respective sensor 2a-2f to the respective objects 10a-10o in a section 7a-7f respectively. As an example, the detection direction for the sensor 2c is shown as an arrow. The detection direction 13 of the sensor 2c thus points in the direction of the objects 10f-10h, which are located in the section 7c belonging to the sensor 2c.

A cone-shaped detection area 14 with a relatively small opening angle (small width of the opening angle) opens around the detection direction 13 starting from the respective sensor 2a-2f, wherein the opening angle is so small that the detection area 14 is limited to a single product guidance structure 8a-8f across the distance from the rear edge to the front edge. This detection area 14 is also shown as an example for the sensor 2c. The other sensors also comprise a detection direction 13 and a detection area 14.

In this exemplary embodiment, each sensor 2a-2f checks and monitors a group of objects 10a-10o, which are arranged in a line from the boundary 9a-9f to the sensor 2a-2f. Each sensor 2a-2f can detect or measure a distance and automatically determine the depth of the product placed there if the distance is detected. The determination data generated by the sensor 2a-2f as a result of this determination, which represents or indicates the determined product depth, can be evaluated or further processed by the sensor 2a-2f itself or by an ERP system or also, for example, a mobile device (not shown), as discussed in the general part of the description.

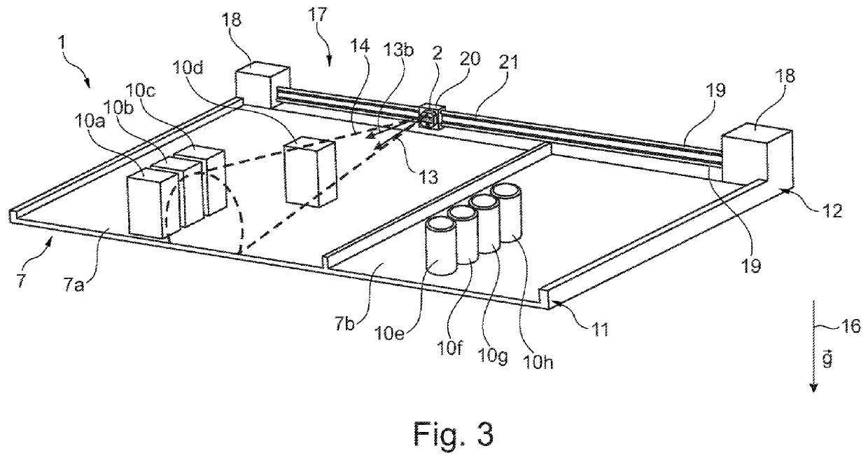

FIG. 3 shows an exemplary embodiment of a shelf 1 without a product guidance structure 8a-8f. In this exemplary embodiment, the rear wall 15 was also omitted to make room for a sensor movement system 17. Nevertheless, a wall can extend behind the sensor movement system 17, for example, to separate two sides of the shelf from each other or to structurally delimit a shelf 1.

The sensor movement system 17 comprises two drive units 18 connected to two rails 19. A carriage 20 is mounted on the rails 19, which can be moved along the rails 19. The sensor 2 is mounted on the carriage 20. The carriage 20 is connected to a belt 21. The drive units 18 are designed to pull the belt 21 via at least one driven pulley inside at least one drive unit 18, thereby moving the carriage 20 and the sensor 2 along the rear edge 12. The movement of the sensor 2 is initiated by an electronic control system that is not shown further and which electronically controls the drive units 18.

The sensor movement system 17 is thus designed to move and position the sensor 2 horizontally in relation to the fall acceleration, represented by the arrow 16, and thus enables a location-variable detection position for the sensor 2.

In front of the sensor movement system 17, there is the storage structure 7, which is divided into two sections 2a, 2b. The storage structure 7, or each section 7a, 7b, comprises the front edge 11 and the rear edge 12. The sensor movement system 17 is at the rear edge 12.

On the storage structure 7, there are also products 10a-10h here.

In this exemplary embodiment, the rear edge 12 of the storage structure 7 is aligned with the front edge 11 in relation to the direction of gravitational acceleration (represented by the arrow 16). Thus, in contrast to the exemplary embodiment described above, objects 10a-10f do not slide to the front edge 11 due to gravitational acceleration but remain in their respective positions until they are moved manually.

The detection direction 13 of the sensor 2 is parallel to the surface of the storage structure 7 and points from the sensor 2 to the front edge 11. However, it is also possible that the sensor 2 is designed to change the detection direction 13 so that it does not have to stand normally in the direction of movement of the sensor 2.

Here, too, the detection area 14 also extends in a conical shape around the detection direction 13. If the sensor movement system 17 moves the sensor 2 along the rear edge 12, it can detect a plurality of areas, wherein conclusions can be drawn about the number of objects in the respective sections where a product group has been placed after subsequent evaluation of the detection results.

Also here, by monitoring the change in the distance between the sensor and the respective product group, which is automatically determined with the aid of the sensor, the sensor itself can determine the depth of the respective product. It is assumed that these changes always occur when, for example, personnel refinish products from the front and the products furthest back are pushed backwards towards the sensor.

Also, in order to determine the depth of the products, the sensor movement system can not be located behind the products but to the side of them. Also, in accordance with another exemplary embodiment, two such sensor movement systems can be provided on the mentioned sides, i.e., on the one hand behind the products and on the other hand to the side of the products so that the detection from two different sides can be carried out from dynamic, i.e., from two location-variable detection positions, which facilitates the automatic determination of the dimensions, and possibly also improves them.

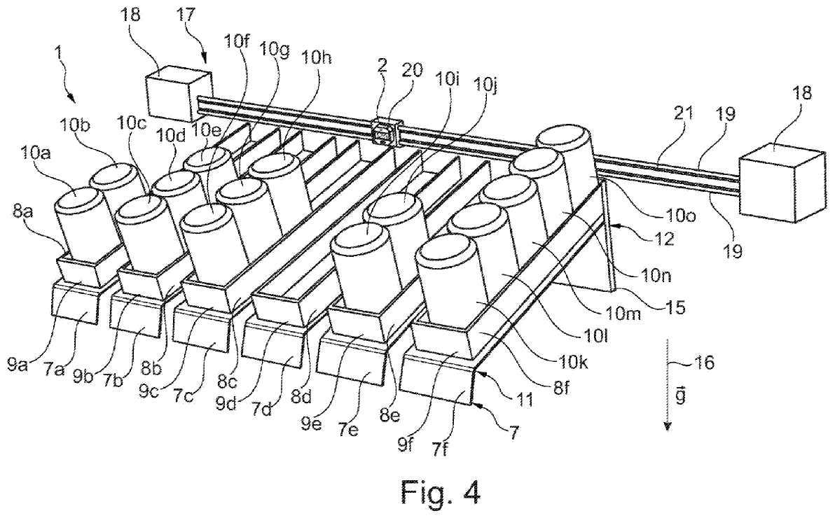

Furthermore, the accuracy of estimating the number of items 10a-10h can be improved and the determination of the depth of the products per product group can also be accelerated if a product guidance structure 8a-8f is provided, as discussed in connection with FIG. 2. An exemplary embodiment having a combination of the product guidance structure 8a-8f and the sensor movement system 17 is shown in FIG. 4.

The storage structure 7 is in front of the sensor movement system 17. Above the rear edge 12, the rear wall 15, which is visible in FIG. 2, is missing in order to enable the sensor 2 to detect the objects 10a-10o that are located in the storage structure 7 in an undisturbed manner.

The storage structure 7, the rear wall 15 running below the rear edge 12 of the storage structure 7 and the drive units 18 can be permanently connected to a support structure not shown, such as a framework or other flat sheet metal parts or walls for example.

Also here, the sensor 2 is orientated in such a way that its detection direction 13, which is not shown in detail, points from the sensor 2 to the front edge 11 and runs parallel to the plane to the extension of the respective sections 7a-7f.

The sensor movement system 17, in particular, the mentioned controller, is designed to move the sensor 2 into discrete positions. These discrete positions here are those in which the detection direction and the line in which the objects 10a-10o are positioned coincide. In this way, the detection of the sensor 2 can be precisely focused on the respective sections 7a-7f and unnecessary intermediate position detections can be avoided.

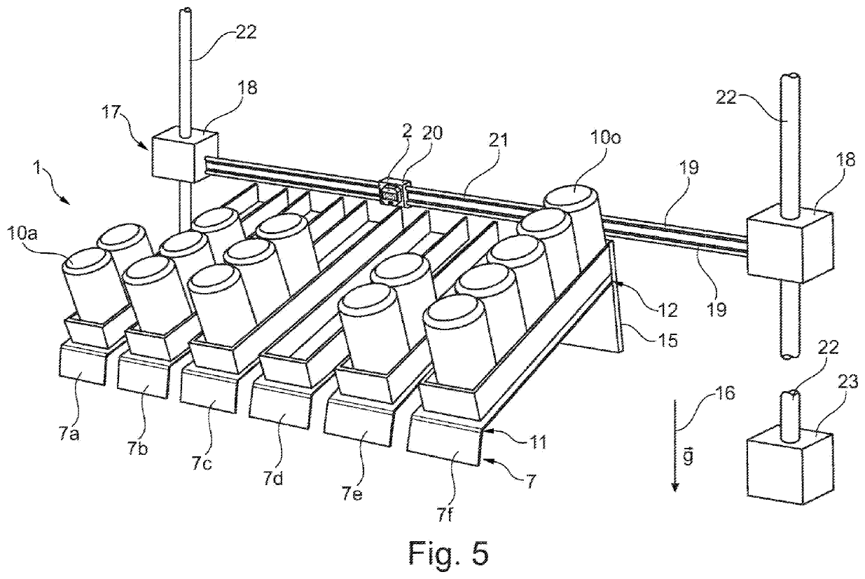

FIG. 5 shows another exemplary embodiment of the product presentation device 1, wherein the sensor 2 can be moved not only horizontally but also vertically. This makes it possible to position the sensor along two degrees of freedom at location-variable detection positions, i.e., to essentially move it over a large area, in particular, to move it across shelves.

In the present case, the shelf 1 comprises a plurality of storage structures 7 (shelf levels) arranged on top of each other, wherein only one of them is shown for the sake of clarity, however. For the sake of clarity, the quantity of reference numbers has also been reduced.

In contrast to FIG. 4, however, each of the two drive units 18 can be moved vertically and encloses a threaded rod 22 with an internal thread. Each threaded rod 22 is driven by a threaded rod drive unit 23. The threaded rod drive unit 23 is permanently connected to the support structure, which is also not shown here. It is therefore fixed relative to the rear wall 15.

The sensor movement system 17 or its threaded rod drive unit 23, controlled by the electronic control system, can not only move the sensor 2 along the rear edge 12 of the displayed storage structure 7, but also move it in planes above or below the displayed storage structure 7. The sensor 2 can therefore detect not only a plurality of sections 7a-7f of a storage structure 7, but also a plurality of storage structures 7, i.e., an entire shelf.

In accordance with this embodiment, the depth of the different products of an entire shelf 1 can be determined with only a single sensor 2.

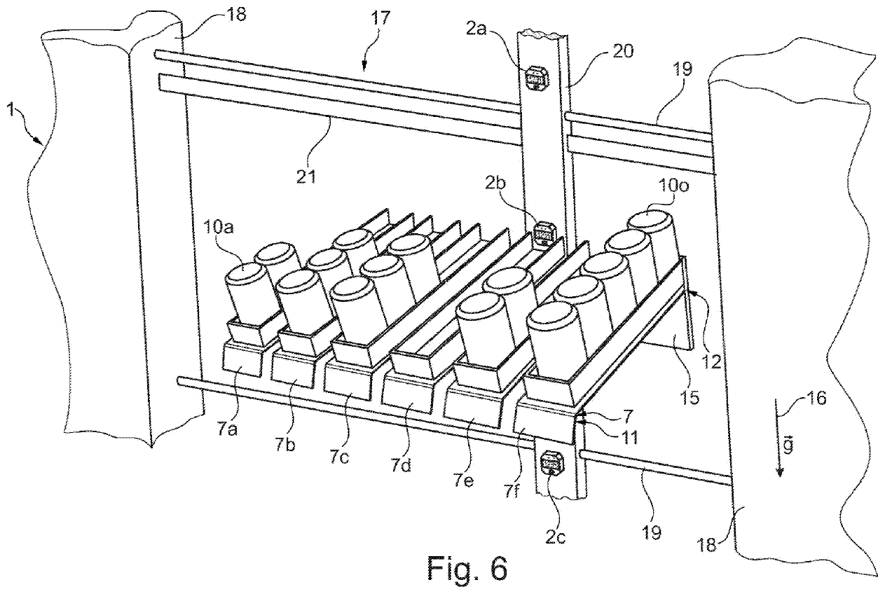

FIG. 6 shows another exemplary embodiment of a sensor movement system 17 for detecting a plurality of stacked storage structures 7. For this purpose, a plurality of sensors 2a-2c on a carriage 20 are provided here, wherein each sensor 2a-2c is assigned to one storage structure 7 respectively. The carriage 20 travels on the two rails 19 along the rear edge 12 of the storage structures 7. The drive units 18 as well as the rear wall 15 are permanently connected to the support structure. The drive units 18 are designed to move the carriage 20 over the belt 21. The middle sensor 2b is assigned to the displayed storage structure 7, which results from its horizontal positioning. The upper sensor 2a and the lower sensor 2c are each assigned to other storage structures 7 not shown here, which results from their individual horizontal location.

If the carriage 20 moves horizontally along the storage structures 7, each sensor detects the objects 10a-10o in the respective storage structures 7.

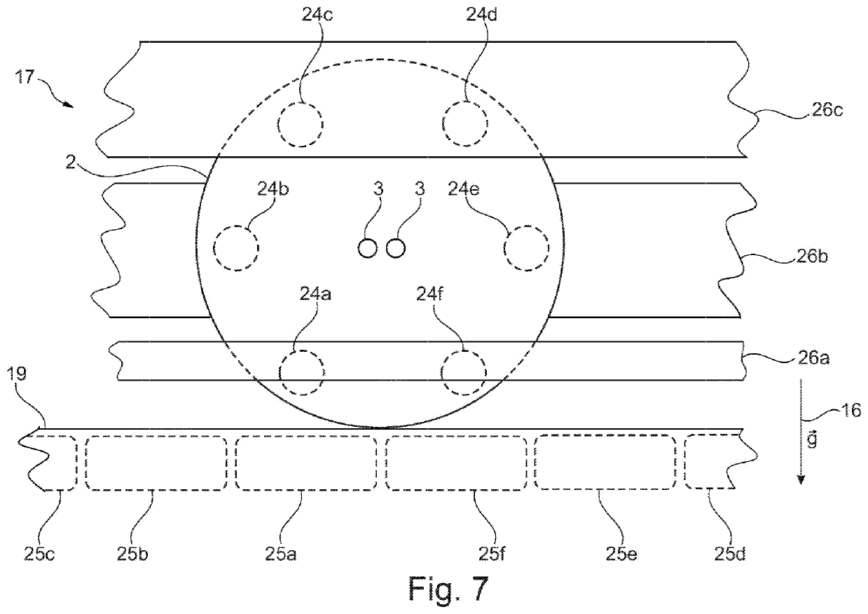

FIG. 7 shows a very space-saving exemplary embodiment for the sensor movement system 17 and for the sensor 2. The sensor 2 is designed as a cylindrical drive wheel. The sensor units 3 are placed close to the centre of the sensor 2. The sensor 2 is located on a rail 19 and is designed to roll on it. The sensor movement system 17 also comprises three bars 26a, 26b and 26c, which are designed to hold the sensor 2 on the rail 19. For this purpose, the lower bar 26a and the upper bar 26c are located on the side of the sensor 2 where the detection area 14 is located, whilst the middle bar 26b is located on the other side. This prevents the sensor 2 from falling off the rail 19.

The sensor 2 comprises six first magnetic elements 24a-24f, which are permanent magnets.

The rail 19 comprises a plurality of second magnetic elements 25a-25f along its entire length, which are electromagnets that can be switched on and off individually.

In the position shown, the two middle second magnetic elements 25a and 25f are switched in such a way that they pull the corresponding first magnetic elements 24a and 24f towards them.

In order to move the sensor 2 further to the right, i.e., to rotate clockwise, the left of the two active second magnetic elements 25a is deactivated and the next right second magnetic element 25e is activated so that the corresponding first magnetic element 24e is pulled down to the rail 19. In addition, the previously active second magnetic element 25a can be activated simultaneously reversed polarity in order to push the corresponding first magnetic element 24a away from the rail 19.

Alternatively, the first magnetic element 24a-24f can be designed as a ferromagnetic magnetic element.

Also, the first magnetic elements 24a-24f can be switchable electromagnets. Accordingly, the second magnetic elements 25a-25b can be permanent magnets or ferromagnetic magnetic elements. The rail 19 can also be made of a corresponding material.

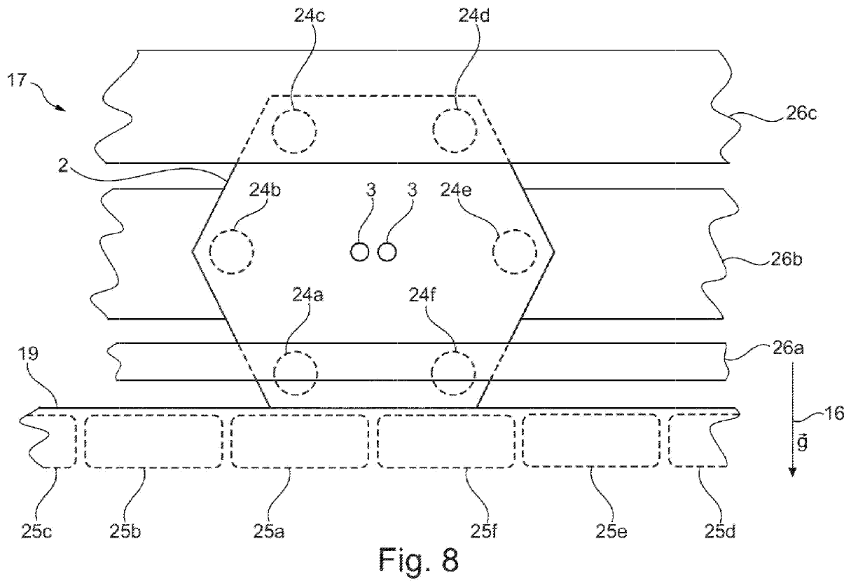

FIG. 8 shows another exemplary embodiment, wherein, in contrast to the exemplary embodiment shown in FIG. 7, the drive wheel is polygonal. This means that those surfaces on which the sensor 2 is in stable positions form essentially a convex polygon in the cross-section normally on these surfaces.

This gives the sensor 2 a secure hold at a desired position even when the electromagnets are not activated.

Furthermore, the sensor 2 can be positioned in specific, discrete positions. The layout of the storage structure 7 can therefore be adapted to the dimensions of the sensor 2 in such a way that the sensor 2 can be placed in the desired discrete positions.

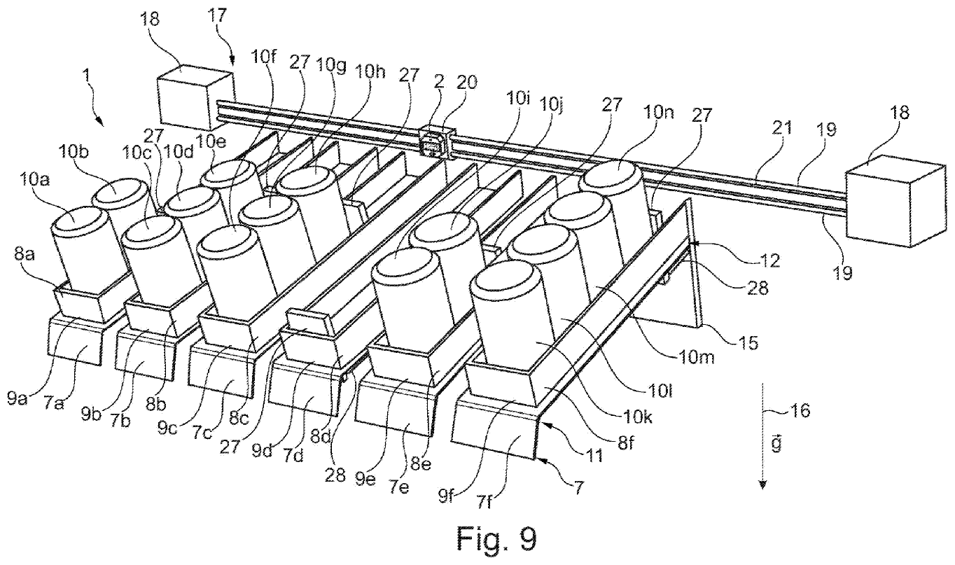

FIG. 9 shows another exemplary embodiment of the shelf 1, which is largely similar to that in FIG. 4. However, in contrast to FIG. 4, the product guidance structure 8a-8f here comprises plate-shaped pushers 27 which are provided to push products 10a-10n placed in the storage structure 7 or its sections 7a-7f to the front edge 11. For this purpose, each pusher 27 is connected to a spring element 28, which pushes the respective pusher 27 away from the rear wall 15 or pushes it towards the front edge 11.

In contrast to FIG. 4, the sensor 2 does not directly detect the distance between the sensor 2 and product 10a-10n but directly detects the distance between the sensor 2 and the pusher 27. However, this makes no difference in the automatic determination of the depth of the product, because the pusher can also only move in accordance with the distance grid specified by the depth of the product or in accordance with a multiple thereof when one product or a plurality of products are removed or refinished from a product group.

At this point, it should also be mentioned that sections 7a-7f do not have to be separate from each other. Rather, they can also be designed as a contiguous level or assembly.

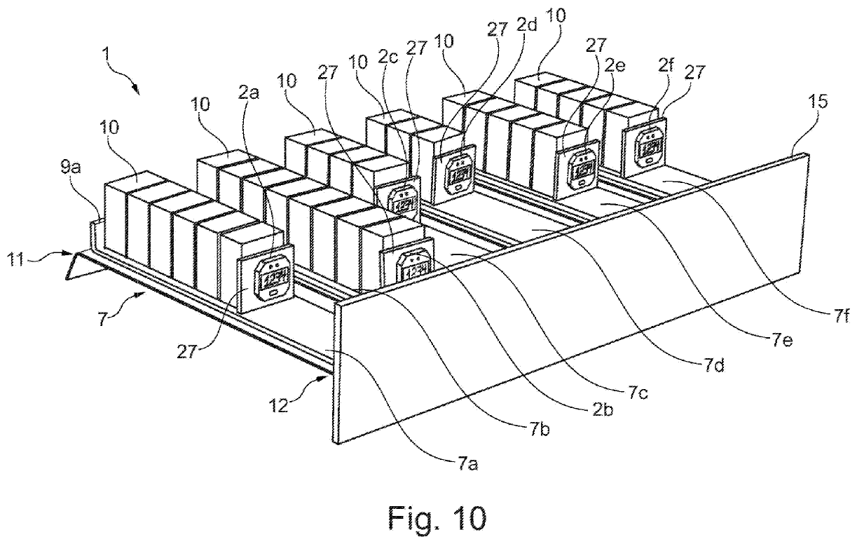

FIG. 10 shows a similar exemplary embodiment in comparison with FIG. 9, wherein, here, each pusher 27 is equipped with a sensor 2 (2a-2f) and the detection direction of the respective sensor 2a-2f is orientated away from the pusher and towards the rear edge of the storage structure (shelf), where the shelf is finalized with a rear wall 15. Here, the sensor 2 is moved according to the number of products removed or refinished relative to the rear wall 15 that forms a reference, and the depth of the respective product is determined from the change in its distance from this reference.

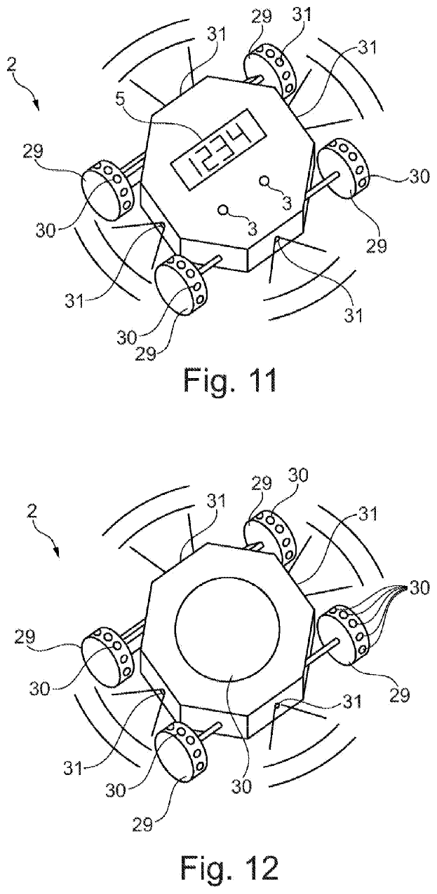

FIGS. 11 and 12 show a self-propelled sensor 2 designed for autonomous manoeuvring in the product presentation device as a sensor vehicle, which comprises an electric drive of which four wheels 29 are visible, wherein two of the wheels 29 are steerable in order to make changes in direction.

As shown in FIG. 11, the sensor 2 comprises sensor units 3 and screen 5 on the back. Furthermore, as can be seen in FIG. 12, the sensor 2 comprises a permanent magnet 30 integrated into its housing on its belly, which is schematically indicated as a circle. FIG. 12 also shows that permanent magnets 30 can also be arranged on the circumferential side of wheels 29. The drive or the positioning of the permanent magnet 30 are dimensioned in such a way that the permanent magnet 30 does not lie directly against the shelf 1, but an air gap towards the shelf 1 remains free.

On its side walls, the sensor 2 comprises navigation sensors 31, which allow its sensor electronics, which are housed in the housing and control the movement of the sensor 2, to orient itself during autonomous movement within the product presentation device, to detect and avoid obstacles or to also recognize structures and recognize them again at a later point in time and, where applicable, to use them for navigation.

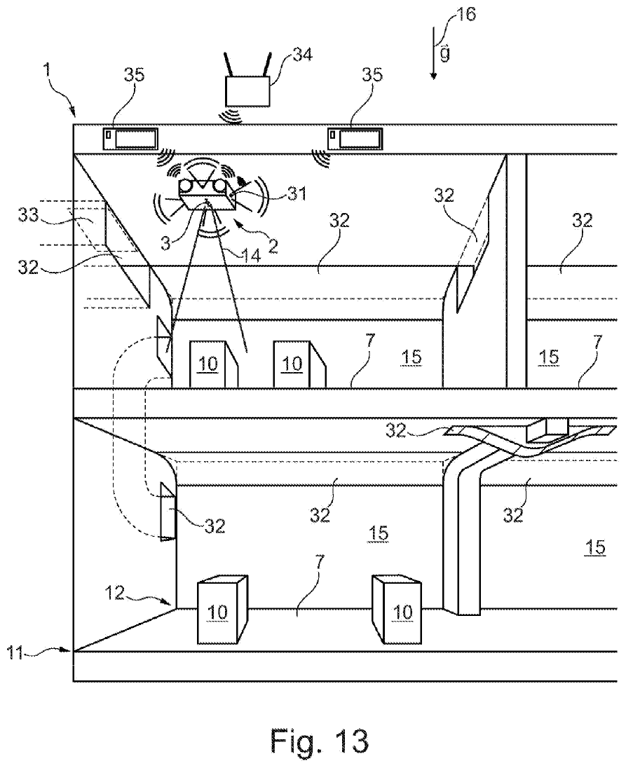

As shown in FIG. 13, the permanent magnet 30 (or the permanent magnets 30 of the wheels 29) allows the sensor 2 to hold on to or adhere to a ferromagnetic structural element (e.g., storage structure 7), such as a shelf made of steel sheets or to a vertical rear wall 15 at a shelf level of the shelf 1. This capability is used, in particular, in such a way that the sensor 2 can move autonomously upside down in the shelf 1, i.e., looking down on the back side of a shelf 7, and from there from a location-variable detection position it can carry out its detection of the products 10 arranged below it in order to determine the dimensions, such as, in particular, the depth, of the products 10 or also the width and height.

Furthermore, it can be seen that the sensor can cross over between the structural elements, even between shelves 1, by using connecting elements 32, which connect the structural elements to each other in a way that can be driven on by the sensor 2. The sensor 2, which is battery-powered, can also drive to a charging station 33, where it can charge its battery storage inductively.

FIG. 13 also shows an access point 34 typical of a communication infrastructure, which is designed and designed for radio communication with the sensor 2 on the one hand and/or for radio communication with electronic labels (ESL) 35 on the other hand, wherein ESLs 35 are attached to the shelving rails of the shelf 1 to display product and/or price information. The ESLs 35 can also be designed to be NFC-capable (NFC stands for Near Field Communication). The same applies to the sensor 2 so that the ESLs 35 can serve as a radio beacon for the sensor 2 if it is in the immediate vicinity (i.e., within the NFC radio range of max. a few centimetres) to the ESLs 35.

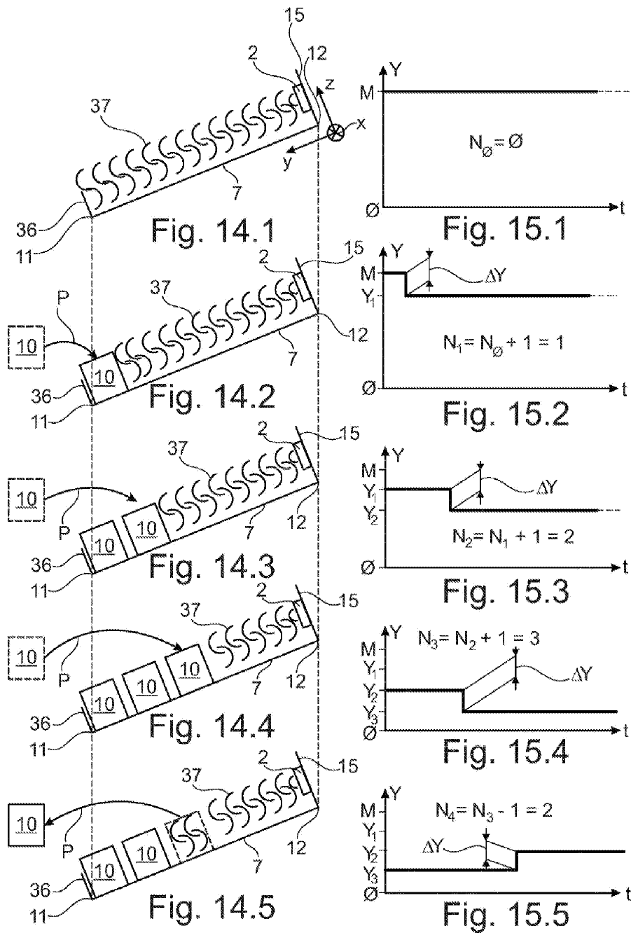

With the aid of FIGS. 14, 15 and 16, the functional principle of the sensor 2 is visualized.

In detail, the corresponding pairs of figures from FIG. 14.1 and FIG. 15.1 up to FIG. 14.5 and FIG. 15.5 show, on the one hand, a shelf 1 that is stocked with products 10 or from which a product 10 is taken (FIGS. 14.1 to 14.5), and on the other hand, the distances to product 10 (FIGS. 15.1 to 15.5) determined by the sensor 2. FIG. 16 visualizes a method sequence of a method provided by the sensor 2 in the form of a flow diagram.

FIG. 14.1 shows a section of the shelf 1, in detail shelf 7, as well as a shelving rail 36 ending shelf 7 on its lower left side (front edge 11 of the shelf 1) from a lateral perspective. Shelf 7 is finalized at its rear edge 12 with the rear wall 15, to which the sensor 2 with detection direction 14 is attached to the front edge 11. Furthermore, a Cartesian coordinate system for the identification of the directions is depicted. In the present case (in this simplified example), the direction of the y-coordinate is orientated from the back edge 11 to the front edge 12 and describes the distance between products 10 and the sensor 2. Furthermore, the sensor signal 37 is shown schematically, wherein it is emitted by the sensor 2 and is reflected back to the sensor 2 on shelving rail 36. The sensor 2 therefore detects the maximum distance M, which corresponds to the depth of shelf 7. The value of the depth detected by the sensor 2 is shown in FIG. 15.1 over time and only changes when a product 10 is placed on shelf 7, as this is visualized in FIG. 14.2 with the aid of the arrow P. The sensor 2 thus detects a shorter distance than before, wherein the time progression of the distance is shown in FIG. 15.2. The change in distance over time, which occurs at the time of refinishing product 10, is shown as Δy in FIG. 15.2. In the other FIGS. 14.3 to 15.4 the refinishing of another two products 10 is visualized, wherein in analogy to FIG. 15.2 two further distance changes Δy occur towards a smaller distance. In principle, the sensor 2 can already determine that these distance changes Δy define the product depth when the first further distance changes Δy occur. However, it can also define the product depth from the multiple sequential occurrence of these distance changes Δy. As soon as the sensor 2 has defined a product depth, it can determine how many products 10 have been refinished on shelf 7 (see figure sequence 14.2 to 15.4) or how many products 10 have been removed from shelf 7 (see figure pair 14.5 and 15.5) based on the number of distance changes that have occurred. The number of products found on the shelf 1 is indicated in the figure sequence 15.1 to 15.5 by the symbol N or the equation given therein.

The method shown in FIG. 16, which is provided with the aid of the electronics of the sensor 2, is shown here broken down into the macroscopic method steps. The illustration of FIG. 16 visualizes a combination of the method for determining a dimension of a product 10 in the product presentation device 1 and an inventory monitoring method.

The method begins in Block I, in which an automatic detection of the change in at least one parameter that is representative of the dimensions of the product is detected. In the context of FIGS. 14.1 to 15.5 described above, this is the distance changes Δy, which is detected with the aid of the sensor 2 located in the shelf 1.

If the sensor 2 is in a learning phase, which is tested in a Block II, the method is continued in a Block III, where an automatic determination of at least one dimension of the product 10 is carried out based on the detected change in the parameter. In the context of FIGS. 14.1 to 15.5 described above, at least one dimension of product 10 is the depth of the product that corresponds exactly to the changes in distance Δy. This product depth is stored in the sensor 2 or communicated wirelessly by the sensor 2 to the merchandise management system. After Block III, the method is resumed at Block I. Depending on the actual implementation, i.e., whether the product depth is determined by a single spacing change Δy or based on multiple spacing changes Δy, the learning phase can include a single pass of the sequence of blocks I to III or a multiple pass of blocks I to III until the sensor 2 has determined a value of the depth of product 10 that is automatically classified as valid. Once there is a valid value for the depth of product 10, the learning phase is exited.

If it is determined that there is no learning phase in Block II, it is branched out to Block IV. In Block IV, the dimension previously determined in the learning phase, i.e., the depth of product 10, is used for inventory monitoring, wherein a change in the number of products is automatically determined on the basis of the change in distance Δy detected in Block I. In the simplest case, this can be done by dividing the detected distance change Δy by the product depth in order to obtain the change in the number of products. This can be further processed in the sensor 2 or transmitted to an ERP system, where further processing takes place.

The change in the number of products automatically determined in this way is checked in Block V to determine whether it meets a criterion for triggering an alarm. These can be different alarms, as discussed in the general description in connection with a restocking alarm and an anti-theft alarm. If one of the criteria discussed in this context is met, i.e., if a positive test result is obtained in Block V, the respective alarm is triggered in Block VI and the method is then continued in Block I. If a negative test result is obtained in Block V, the method is continued directly at Block I starting from Block V.

Even though an infinite loop was depicted in the discussion of the methods visualized in FIG. 16, it should be noted at this point that there can, of course, be a start and an end of the method, wherein these circumstances can result from external influence on the sensor. For example, a start can be caused by the insertion of batteries. Likewise, the end can be caused by the removal of batteries. The processing sequence of the sensor 2 can also be influenced by radio interference (remote control).

Ultimately, it is pointed out once again that the figures described in detail above are only exemplary embodiments, which can be modified by the person skilled in the art in various ways without leaving the field of the invention. For the sake of completeness, it is also pointed out that the use of the indefinite article “a” does not exclude that the respective features can also be present a multiple of times.

1. Method for determining a dimension of a product (10) placed in a product presentation device (1), wherein the method comprises the following steps, namely:
automatic detection of a change in a parameter that is representative of at least one dimension of the product (10), wherein the parameter is detected by means of an electronic sensor (2) and the sensor (2) is located in the product presentation device (1), and
automatic determination of at least one dimension of the product (10) based on the detected change in the parameter.

2. Method according to claim 1, wherein the sensor (2)
can either be positioned in a variable location
or is permanently located.

3. Method according to claim 1, wherein the sensor (2) comprises at least one of the following formations, namely:
a time-of-flight sensor,
a camera,
a 3D-camera system,
a time-of-flight camera,
a LIDAR,
as a pressure-sensitive sensor mat,
as a sensor mat with an array of light-sensitive elements.

4. Method according to claim 1, wherein the determination of the dimension of the product (10) is carried out only when a learning period has been triggered.

5. Method according to claim 4, wherein the observed change in the representative parameter is checked for at least one trigger and the learning phase is triggered when the presence of this trigger is detected.

6. Method according to any one of the preceding claims, wherein the determination of the dimension of the product (10) is made directly from a single change in the parameter.

7. Method according to claim 1, the determination of the dimension of the product (10) is made from a plurality of changes in the parameter.

8. Method according to claim 1, wherein the determination of at least one dimension is carried out by means of artificial intelligence, which processes or evaluates the changes in the representative parameter.

9. Method according to claim 1, wherein,
the dimension of the product (10) is its depth measured in the direction of the depth of the product presentation device (1) or a storage structure, and wherein
the change in the parameter is given by a change in distance (□y) in the direction of the depth of the product presentation device (1) or the depth of the storage structure, as determined by the sensor (2), and wherein
the depth of the product (10) is determined by the detected change in distance (□y).

10. Method according to claim 1, wherein a sensor (2) based on time-of-flight measurement of a sensor signal (2) is used, in particular, with a resolution in the cm range or sub-cm range.

11. Inventory monitoring method for monitoring the inventory in a product presentation device (1) in which at least one product (10) can be placed,
wherein for the product (10) at least one dimension which is representative for inventory monitoring, in particular, the depth of the product (10), is known in advance, in particular, in accordance with the method according to any one of the claims 1 to 10,
wherein the inventory monitoring method consists of the following method steps, namely:
automatic detection of a change in a parameter that is representative of at least one dimension of the product (10), wherein the parameter is detected by means of an electronic sensor (2) and the sensor (2) is located in the product presentation device (1), and
automatic detection of a change in the number of products, wherein the change in the representative parameter is evaluated with relation to at least one representative dimension for inventory monitoring.

12. Method of monitoring inventory according to claim 11, wherein it is examined whether the automatically detected change in the number of products leads to a fall below a threshold value of the number of products, wherein, in the event of a positive test result, a restocking alarm is triggered.

13. Method of monitoring inventory according to claim 11, wherein it is examined whether an automatically detected change in the number of products leads to an exceedance of a threshold value of the change in the number of products, wherein a theft alarm is triggered in the event of a positive test result.

14. Inventory monitoring method according to claim 12, wherein product-specific or product group-specific threshold values are used in the test.

15. A method of monitoring inventory according claim 11, wherein, during automatic detection of the change in the quantity of products, an additional system component is taken into account, in particular, a billing or cash register system to which the change in the number of products is communicated electronically, or an optical monitoring system by means of which a digital recording of the product presentation device (1) is created, in which the change in the number of products has been detected.
